(19) United States
(12) Patent Application Publication
(10) Pub. No.: US 2025/0037473 A1
(43) Pub. Date: Jan. 30, 2025

(54) SYSTEMS AND METHODS OF TRAFFIC MEASUREMENT USING IMAGE CAPTURE DEVICES VIA COMPUTER VISION

(71) Applicant: Walmart Apollo, LLC, Bentonville, AR (US)

(72) Inventors: Jaley Himmatbhai Dholakiya, Bengaluru (IN); Rajesh Shreedhar Bhat, Irving, TX (US); Shuchi Sureka, Dibrugarh (IN); Edward Marc Welsh, Bella Vista, AR (US); Satpalsingh Jaspalsingh Ghunia, Mumbai (IN); Sicheng Wang, Plano, TX (US); Rajat Gupta, Jaipur (IN); Naveen Selvam Ravichandran, Chennai (IN); Ziyi Tang, Dallas, TX (US); David Michael Barry, Carrollton, TX (US); Harsha Raja Shivakumar, Irving, TX (US); Xingming Qu, Frisco, TX (US); Xian Wang, Southlake, TX (US); Chaitanya Kumar Seri, Cupertino, CA (US); Andrew Wesley Minteer, Frisco, TX (US); Andrew Jonathan Stevens, Southlake, TX (US)

(21) Appl. No.: 18/357,892

(22) Filed: Jul. 24, 2023

(51) Int. Cl. G06V 20/52; G06T 7/11; G06T 7/20; G06V 10/22; G06V 10/25; G06V 10/762; G06V 10/766; G06V 10/774

(52) U.S. Cl. CPC G06V 20/53; G06T 7/11; G06T 7/20; G06V 10/225; G06V 10/25; G06V 10/762; G06V 10/766; G06V 10/774; G06T 2207/20081; G06T 2207/20084; G06T 2207/20132; G06T 2207/30196; G06T 2207/30241; G06T 2207/30242; G06V 10/82

(57) ABSTRACT

Systems and methods for traffic measurement are disclosed. An image capture device is configured to generate image data including an area of interest within a physical environment containing at least one engagement feature. The image data is received and model input image data including a plurality of cropped images is generated by applying a zoom-in crop process to the image data. An image processing model generates a person count and dwell time. The image processing model receives the model input image data as an input. An engagement metric is generated based on the person count and the dwell time. The engagement metric is representative of engagement with the at least one engagement feature.

### TECHNICAL FIELD

This application relates generally to automated image recognition, and more particularly, to position and trajectory tracking.

### BACKGROUND

The flow of traffic within an environment, such as a retail environment, can provide useful information regarding utilization and engagement for users within the environment. For example, the movement of individuals within a retail environment can indicate engagement of users within specific portions, areas, facings, and/or other divisions of the physical space, including engagement with fixtures or other items within a division. Operators of physical spaces, such as retail operators, may wish to measure engagement with specific portions of a store for space utilization, planning, and/or other purposes.

Some current processes for determining user-engagement rely on survey-based statistics to provide estimates of monthly visits to an environment, such as a retail environment. Obtaining survey-based statistics is expensive and inefficient, as it requires direct user interaction, and fails to provide accurate information regarding daily, weekly, monthly, or yearly utilization of space. Some current systems include radio-frequency identification (RFID) systems deployed in shopping carts or other in-store items to track movement within the environment. However, installation of RFID and similar systems can require a large investment of time, money, manpower, and materials.

### SUMMARY

In various embodiments, a system is disclosed. The system includes an image capture device configured to generate image data including an area of interest within a physical environment containing at least one engagement feature, a non-transitory memory, and a processor communicatively coupled to the non-transitory memory. The processor is configured to read a set of instructions to receive the image data, generate model input image data including a plurality of cropped images by applying a zoom-in crop process to the image data, implement an image processing model to generate a person count and dwell time, and generate an engagement metric based on the person count and the dwell time. The image processing model receives the model input image data as an input and the engagement metric is representative of engagement with the at least one engagement feature.

In various embodiments, a computer-implemented method is disclosed. The computer-implemented method includes a step of receiving image data from an image capture device. The image data includes an area of interest within a physical environment containing at least one engagement feature. The computer-implemented method further includes the steps of generating model input image data including a plurality of cropped images by applying a zoom-in crop process to the image data, implementing an image processing model to generate a person count and dwell time, and generating an engagement metric based on the person count and the dwell time. The image processing model receives the model input image data as an input and the engagement metric is representative of engagement with the at least one engagement feature.

In various embodiments, a computer-implemented method is disclosed. The computer-implemented method includes steps of receiving a first training dataset including image data representative of an area of interest within a physical environment containing at least one engagement feature and iteratively training a model framework to generate an intermediate model based on the first training dataset. The model framework is configured to identify one or more bounding boxes representative of one or more individuals within the area of interest of the image data and the model framework is configured to receive the image data as an input. The computer-implemented method further includes generating output image data including the image data and the one or more bounding boxes and receiving a second training dataset. The output image data is generated by the intermediate model and the second training dataset includes modified output image data comprising the output image data with one or more bounding box corrections applied. The computer-implemented method further includes iteratively training the intermediate model to generate a trained image processing model based on the second training dataset.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 illustrates a computer system configured to implement one or more processes, in accordance with some embodiments;

FIG. 2 illustrates an environment configured to generate engagement statistics utilizing image recognition derived dwell times, in accordance with some embodiments;

FIG. 3 illustrates an artificial neural network, in accordance with some embodiments;

FIG. 4 illustrates a tree-based artificial neural network, in accordance with some embodiments;

FIG. 5 illustrates a deep neural network, in accordance with some embodiments;

FIG. 6 is a flowchart illustrating a method of engagement determination utilizing image recognition derived dwell times, in accordance with some embodiments;

FIG. 7 is a process flow illustrating various steps of the method of engagement determination utilizing image recognition derived dwell times, in accordance with some embodiments;

FIG. 8 is a flowchart illustrating a zoom-in crop method, in accordance with some embodiments;

FIG. 9 illustrates a 360° image obtained by a 360° view camera, in accordance with some embodiments;

FIG. 10A illustrates a first cropped portion of the 360° image of FIG. 9, in accordance with some embodiments;

FIG. 10B illustrates a second cropped portion of the 360° image of FIG. 9, in accordance with some embodiments;

FIG. 10C illustrates a third cropped portion of the 360° image of FIG. 9, in accordance with some embodiments;

FIG. 11 is a flowchart illustrating a frame differencing method 400, in accordance with some embodiments;

FIG. 12 illustrates a method of generalizing at least one engagement metric for a first physical environment to one or more additional physical environments, in accordance with some embodiments;

FIG. 13 illustrates an end-to-end pipeline for engagement estimation, in accordance with some embodiments;

FIG. 14 is a flowchart illustrating a method of generating a trained image processing model, in accordance with some embodiments; and

FIG. 15 illustrates a process flow of various steps of the method, in accordance with some embodiments.

### DETAILED DESCRIPTION

This description of the exemplary embodiments is intended to be read in connection with the accompanying drawings, which are to be considered part of the entire written description. The drawing figures are not necessarily to scale and certain features of the invention may be shown exaggerated in scale or in somewhat schematic form in the interest of clarity and conciseness. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein can be assigned to the other claimed objects and vice versa. In other words, claims for the systems can be improved with features described or claimed in the context of the methods. In this case, the functional features of the method are embodied by objective units of the systems.

Furthermore, in the following, various embodiments are described with respect to methods and systems for engagement determination utilizing image recognition derived dwell times. In various embodiments, one or more image capture devices are positioned within a physical space to capture image data including at least a portion of the physical space. The one or more image capture devices can include any suitable digital imaging system configured to obtain computer-readable images. For example, in some embodiments, the one or more image capture devices include 360 degree view cameras.

An image processing system is configured to receive the image data form the one or more image capture devices and identify bounding boxes for elements, such as one or more individuals, positioned in the field of view (FOV) of the image capture device. In some embodiments, the image processing system applies crop and zoom-in processes to process different portions of the image data from one of the one or more image capture devices. In some embodiments, the image processing system is configured to a frame differencing process to reduce static false positives. The image processing system can apply one or more trained image processing models, such as a trained machine learning model generated using a human in the loop (HITL) step, to perform image recognition for the selected elements, e.g., for individuals.

In some embodiments, after detecting individuals within the image data, the image processing system applies an engagement determination process. The engagement determination process is configured to apply a dwelling time and person count combination to generate an engagement metric. As discussed in greater detail below, dwell time determination identifies the amount of time that a tracked individual is within a predetermined distance and/or a predetermined orientation of a selected portion of the physical environment and person count is a count of the number of distinct individuals detected in the image data.

In some embodiments, systems, and methods for engagement determination utilizing image recognition derived dwell times includes one or more HITL processes. HITL processes include training of a machine learning (or other automated) system with at least some human input. For example, in the context of machine learning, a HITL process includes human identification of relevant data or portions of a data for training of a machine learning model. In some embodiments, an image processing system implements a trained machine learning image recognition model that is trained utilizing a HITL process in which a human identifies individuals within training image data, trajectories of individuals within training image data, and/or other features of the training image data prior to iterative training of the machine learning image recognition model.

In general, a trained function mimics cognitive functions that humans associate with other human minds. In particular, by training based on training data the trained function is able to adapt to new circumstances and to detect and extrapolate patterns.

In general, parameters of a trained function can be adapted by means of training. In particular, a combination of supervised training, semi-supervised training, unsupervised training, reinforcement learning and/or active learning can be used. Furthermore, representation learning (an alternative term is “feature learning”) can be used. In particular, the parameters of the trained functions can be adapted iteratively by several steps of training.

In particular, a trained function can comprise a neural network, a support vector machine, a decision tree and/or a Bayesian network, and/or the trained function can be based on k-means clustering, Qlearning, genetic algorithms and/or association rules. In particular, a neural network can be a deep neural network, a convolutional neural network, or a convolutional deep neural network. Furthermore, a neural network can be an adversarial network, a deep adversarial network and/or a generative adversarial network.

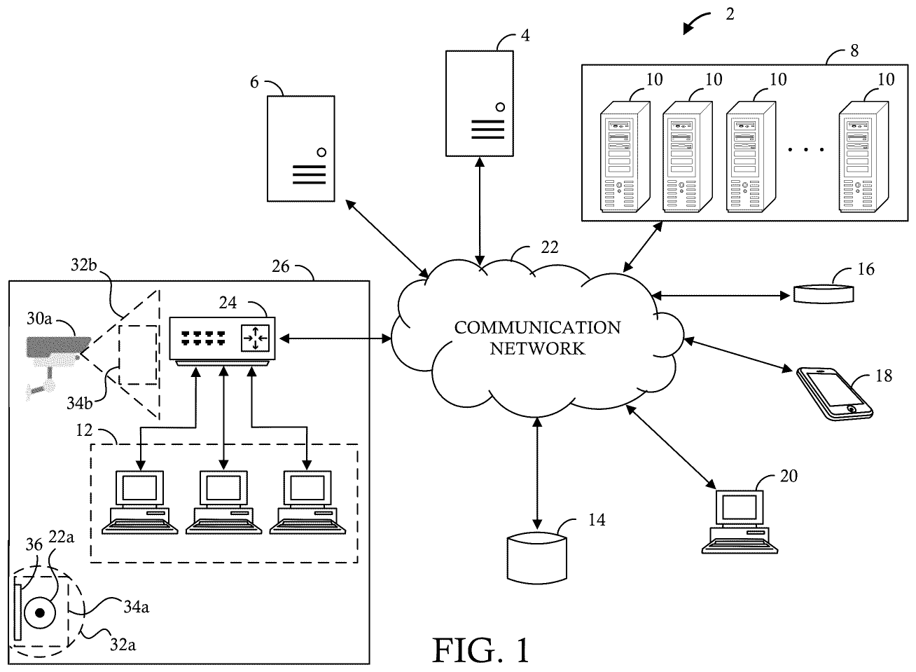

FIG. 1 illustrates a computer system configured to implement one or more processes, in accordance with some embodiments. The system 2 is a representative device and can include a processor subsystem 4, an input/output subsystem 6, a memory subsystem 8, a communications interface 10, and a system bus 12. In some embodiments, one or more than one of the system 2 components can be combined or omitted such as, for example, not including an input/output subsystem 6. In some embodiments, the system 2 can include other components not combined or comprised in those shown in FIG. 1. For example, the system 2 can also include, for example, a power subsystem. In other embodiments, the system 2 can include several instances of the components shown in FIG. 1. For example, the system 2 can include multiple memory subsystems 8. For the sake of conciseness and clarity, and not limitation, one of each of the components is shown in FIG. 1.

The processor subsystem 4 can include any processing circuitry operative to control the operations and performance of the system 2. In various aspects, the processor subsystem 4 can be implemented as a general purpose processor, a chip multiprocessor (CMP), a dedicated processor, an embedded processor, a digital signal processor (DSP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The processor subsystem 4 also can be implemented by a controller, a microcontroller, an application specific integrated circuit (ASIC), a field programmable gate array (FPGA), a programmable logic device (PLD), and so forth.

In various aspects, the processor subsystem 4 can be arranged to run an operating system (OS) and various applications. Examples of an OS comprise, for example, operating systems generally known under the trade name of Apple OS, Microsoft Windows OS, Android OS, Linux OS, and any other proprietary or open-source OS. Examples of applications comprise, for example, network applications, local applications, data input/output applications, user interaction applications, etc.

In some embodiments, the system 2 can include a system bus 12 that couples various system components including the processor subsystem 4, the input/output subsystem 6, and the memory subsystem 8. The system bus 12 can be any of several types of bus structure(s) including a memory bus or memory controller, a peripheral bus or external bus, and/or a local bus using any variety of available bus architectures including, but not limited to, 9-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect Card International Association Bus (PCMCIA), Small Computers Interface (SCSI) or other proprietary bus, or any custom bus suitable for computing device applications.

In some embodiments, the input/output subsystem 6 can include any suitable mechanism or component to enable a user to provide input to system 2 and the system 2 to provide output to the user. For example, the input/output subsystem 6 can include any suitable input mechanism, including but not limited to, a button, keypad, keyboard, click wheel, touch screen, motion sensor, microphone, camera, etc.

In some embodiments, the input/output subsystem 6 can include a visual peripheral output device for providing a display visible to the user. For example, the visual peripheral output device can include a screen such as, for example, a Liquid Crystal Display (LCD) screen. As another example, the visual peripheral output device can include a movable display or projecting system for providing a display of content on a surface remote from the system 2. In some embodiments, the visual peripheral output device can include a coder/decoder, also known as Codecs, to convert digital media data into analog signals. For example, the visual peripheral output device can include video Codecs, audio Codecs, or any other suitable type of Codec.

The visual peripheral output device can include display drivers, circuitry for driving display drivers, or both. The visual peripheral output device can be operative to display content under the direction of the processor subsystem 4. For example, the visual peripheral output device may be able to play media playback information, application screens for application implemented on the system 2, information regarding ongoing communications operations, information regarding incoming communications requests, or device operation screens, to name only a few.

In some embodiments, the input/output subsystem 6 can include an image capture device operative to obtain computer-readable image data from a selected portion of a physical environment. The image capture device can include any suitable image capture device, such as, for example, a charge-coupled device (CCD), an electron-multiplying charge-coupled device (EMCCD), a complementary metal-oxide-semiconductor (CMOS) device, a back-illuminated CMOS, and/or any other suitable image capture device. The image capture device can be configured to obtain still images and/or continuous images. Still images can be obtained at a predetermined interval, a variable interval, upon receipt of a trigger signal, and/or according to any other suitable mechanism.

In some embodiments, the communications interface 10 can include any suitable hardware, software, or combination of hardware and software that is capable of coupling the system 2 to one or more networks and/or additional devices. The communications interface 10 can be arranged to operate with any suitable technique for controlling information signals using a desired set of communications protocols, services, or operating procedures. The communications interface 10 can include the appropriate physical connectors to connect with a corresponding communications medium, whether wired or wireless.

Vehicles of communication comprise a network. In various aspects, the network can include local area networks (LAN) as well as wide area networks (WAN) including without limitation Internet, wired channels, wireless channels, communication devices including telephones, computers, wire, radio, optical or other electromagnetic channels, and combinations thereof, including other devices and/or components capable of/associated with communicating data. For example, the communication environments comprise in-body communications, various devices, and various modes of communications such as wireless communications, wired communications, and combinations of the same.

Wireless communication modes comprise any mode of communication between points (e.g., nodes) that utilize, at least in part, wireless technology including various protocols and combinations of protocols associated with wireless transmission, data, and devices. The points comprise, for example, wireless devices such as wireless headsets, audio and multimedia devices and equipment, such as audio players and multimedia players, telephones, including mobile telephones and cordless telephones, and computers and computer-related devices and components, such as printers, network-connected machinery, and/or any other suitable device or third-party device.

Wired communication modes comprise any mode of communication between points that utilize wired technology including various protocols and combinations of protocols associated with wired transmission, data, and devices. The points comprise, for example, devices such as audio and multimedia devices and equipment, such as audio players and multimedia players, telephones, including mobile telephones and cordless telephones, and computers and computer-related devices and components, such as printers, network-connected machinery, and/or any other suitable device or third-party device. In various implementations, the wired communication modules can communicate in accordance with a number of wired protocols. Examples of wired protocols can include Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, to name only a few examples.

Accordingly, in various aspects, the communications interface 10 can include one or more interfaces such as, for example, a wireless communications interface, a wired communications interface, a network interface, a transmit interface, a receive interface, a media interface, a system interface, a component interface, a switching interface, a chip interface, a controller, and so forth. When implemented by a wireless device or within wireless system, for example, the communications interface 10 can include a wireless interface comprising one or more antennas, transmitters, receivers, transceivers, amplifiers, filters, control logic, and so forth.

In various aspects, the communications interface 10 can provide data communications functionality in accordance with a number of protocols. Examples of protocols can include various wireless local area network (WLAN) protocols, including the Institute of Electrical and Electronics Engineers (IEEE) 802.xx series of protocols, such as IEEE 802.11a/b/g/n/ac/ax/be, IEEE 802.16, IEEE 802.20, and so forth. Other examples of wireless protocols can include various wireless wide area network (WWAN) protocols, such as GSM cellular radiotelephone system protocols with GPRS, CDMA cellular radiotelephone communication systems with 1×RTT, EDGE systems, EV-DO systems, EV-DV systems, HSDPA systems, the Wi-Fi series of protocols including Wi-Fi Legacy, Wi-Fi 1/2/3/4/5/6/6E, and so forth. Further examples of wireless protocols can include wireless personal area network (PAN) protocols, such as an Infrared protocol, a protocol from the Bluetooth Special Interest Group (SIG) series of protocols (e.g., Bluetooth Specification versions 5.0, 6, 7, legacy Bluetooth protocols, etc.) as well as one or more Bluetooth Profiles, and so forth. Yet another example of wireless protocols can include near-field communication techniques and protocols, such as electro-magnetic induction (EMI) techniques. An example of EMI techniques can include passive or active radio-frequency identification (RFID) protocols and devices. Other suitable protocols can include Ultra-Wide Band (UWB), Digital Office (DO), Digital Home, Trusted Platform Module (TPM), ZigBee, and so forth.

In some embodiments, at least one non-transitory computer-readable storage medium is provided having computer-executable instructions embodied thereon, wherein, when executed by at least one processor, the computer-executable instructions cause the at least one processor to perform embodiments of the methods described herein. This computer-readable storage medium can be embodied in memory subsystem 8.

In some embodiments, the memory subsystem 8 can include any machine-readable or computer-readable media capable of storing data, including both volatile/non-volatile memory and removable/non-removable memory. The memory subsystem 8 can include at least one non-volatile memory unit. The non-volatile memory unit is capable of storing one or more software programs. The software programs can contain, for example, applications, user data, device data, and/or configuration data, or combinations therefore, to name only a few. The software programs can contain instructions executable by the various components of the system 2.

In various aspects, the memory subsystem 8 can include any machine-readable or computer-readable media capable of storing data, including both volatile/non-volatile memory and removable/non-removable memory. For example, memory can include read-only memory (ROM), random-access memory (RAM), dynamic RAM (DRAM), Double-Data-Rate DRAM (DDR-RAM), synchronous DRAM (SDRAM), static RAM (SRAM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk memory (e.g., floppy disk, hard drive, optical disk, magnetic disk), or card (e.g., magnetic card, optical card), or any other type of media suitable for storing information.

In one embodiment, the memory subsystem 8 can contain an instruction set, in the form of a file for executing various methods, such as methods for end-to-end simulation including hybrid input modeling, as described herein. The instruction set can be stored in any acceptable form of machine-readable instructions, including source code or various appropriate programming languages. Some examples of programming languages that can be used to store the instruction set comprise, but are not limited to: Java, C, C++, C #, Python, Objective-C, Visual Basic, or .NET programming. In some embodiments a compiler or interpreter is comprised to convert the instruction set into machine executable code for execution by the processor subsystem 4.

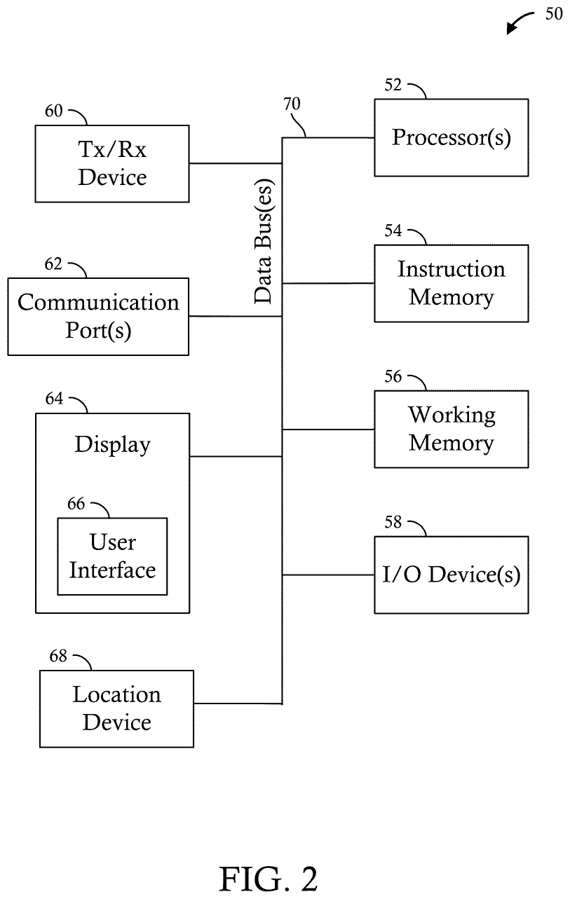

FIG. 2 illustrates an environment 20 configured for engagement determination utilizing image recognition derived dwell times, in accordance with some embodiments. The environment 20 includes a plurality of systems configured to communicate over one or more network channels, illustrated as network cloud 40. For example, in various embodiments, the environment 20 can include, but is not limited to, one or more image capture devices 22a, 22b, an image processing system 24, an engagement determination system 26, and an image database 28. It will be appreciated that any of the illustrated systems can include a system as described above in conjunction with FIG. 1. Although specific embodiments are discussed, herein it will be appreciated that additional systems, servers, storage mechanism, etc. can be included within the network environment 20.

Further, although embodiments are illustrated herein having individual, discrete systems, it will be appreciated that, in some embodiments, one or more systems can be combined into a single logical and/or physical system. For example, in various embodiments, the image processing system 24 and the engagement determination system 26 can be combined into a single logical and/or physical system. Similarly, although embodiments are illustrated having a single instance of each system, it will be appreciated that additional instances of a system can be implemented within the environment 20. In some embodiments, two or more systems can be operated on shared hardware in which each system operates as a separate, discrete system utilizing the shared hardware, for example, according to one or more virtualization schemes.

In some embodiments, each of the image capture devices 22a, 22b are positioned to obtain image data within a FOV 32a, 32b including a portion of a physical environment 30. The FOV 32a, 32b of each of the image capture devices 22a, 22b can include overlapping, partially overlapping, and/or independent portions of the physical environment 30. The FOV 32a, 32b of each of the image capture devices 22a, 22b can include a partial field of view due to physical obstructions, image capture limitations, etc. For example, as illustrated in FIG. 2, the first image capture device 22a includes a partial FOV 32a that stops at a physical barrier, e.g., a wall of the physical environment 30.

In some embodiments, the FOV 32a, 32b for each of the image capture devices 22a, 22b includes a portion of the physical environment 30 configured for occupation and/or navigation by one or more individuals. For example, in some embodiments, the physical environment 30 includes a retail environment that includes fixtures containing one or more items and defining travel paths through the retail environment. The FOV 32a, 32b of each image capture device 22a, 22b can be configured to include at least a portion of the defined travel paths.

In some embodiments, the FOV 32a, 32b of one or more of the image capture devices 22a, 22b includes an engagement feature 36 within the physical environment. For example, to continue the example from above, in embodiments including a retail environment, the FOV 32a, 32b of an image capture device 22a, 22b can include an engagement feature 36 such as a television wall containing a plurality of televisions for sale (referred to herein as a “TV Wall”), a specific fixture including predefined items, etc. In some embodiments, image data generated by one or more image capture devices 22a, 22b can be processed to determine engagement of individuals within the corresponding area of interest 34a, 34b with respect to the engagement features 36.

In some embodiments, an image processing system 24 is in signal communication with the one or more image capture devices 22a, 22b and/or one or more databases configured to receive and store image data from the image capture devices 22a, 22b, such as the image database 28. The image processing system 24 is configured to receive image data from the image capture devices 22a, 22b and/or the image database 28 and perform image processing. In some embodiments, the image processing system 24 is configured to implement one or more trained image processing models to detect individuals within the received image data, draw bounding boxes around each detected individual, and track detected individuals within the image data. The image processing system 24 can be further configured to determine trajectories, orientation, dwell time, and/or other features of individuals within the image data.

In some embodiments, the image processing system 24 is configured to utilize one or more trained image processing models. The trained image processing models can be configured to perform one or more computer vision processing tasks. For example, in some embodiments, one or more trained image processing models are configured to perform image recognition (e.g., detecting persons within image data), object localization (e.g., identifying a location of an object or person within the image data), object tracking (e.g., determining a moving or changing position of a detected object or person within the image data), and/or any other suitable image processing task. The trained image processing models can include any suitable image processing model, such as, for example, deep learning model or framework such as Convolutional Neural Networks (CNNs), Region-Based CNNs (R-CNNs), Faster R-CNN with Region Proposal Networks (RPN), Mask R-CNNs, You Only Look Once (YOLO) models, You Only Learn One Representation (YOLOR) models, and/or other suitable deep learning models. Although embodiments are discussed herein including deep learning models, it will be appreciated that any suitable machine learning framework configured to image processing tasks can be used.

In some embodiments, the one or more trained image processing models are configured to utilize person detection models customized for specific portions of a physical environment and/or specific image input. For example, in some embodiments, a person detection model can be generated by training an image processing framework to detect persons within image data obtained from a specific portion of a retail environment, such as a portion of a retail environment corresponding to a “display wall” section. As another example, in some embodiments, a person detection model can be additionally and/or alternatively generated by training an image processing framework to detect persons within a specific type of image data, such as image data obtained by 360 degree view cameras. The person detection models can be configured to utilize static environmental features to reduce or eliminate false positive detections, for example, utilizing a frame differencing and/or zoom-in approach.

In some embodiments, the image processing system 24 is in signal communication with (and/or combined with) an engagement determination system 26. The engagement determination system 26 is configured to receive processed image data from the image processing system 24. The processed image data can include, but is not limited to, person detection, person counts, person trajectories, and/or other data generated by one or more trained image processing models. In some embodiments, the engagement determination system 26 is configured to receive processed image data from multiple image processing systems 24 configured to process image data from one or more physical environments.

In some embodiments, the engagement determination system 26 is configured to apply one or more statistical correction techniques to generate an accurate person count estimate for the monitored portions of the physical environment. For example, in some embodiments, a predicted person count is generated and utilized to generate a scaling factor that is applied to the calculated person count. Statistical correction can be applied to correct overcounting of persons that may occur due to occlusion (e.g., the presence of other objects or persons that causes a person to be blocked from and/or reenter a FOV 32a, 32b of an image capture device 22a, 22b, presence of excluded individuals (e.g., an engagement count for a retail environment can exclude the presence of retail employees), individuals within areas outside of an area of interest (e.g., an image capture device 22a, 22b FOV 32a, 32b including additional portions of an environment outside of an area of interest for engagement measurement), eliminate the need for ROI filtering, etc.

In some embodiments, the engagement determination system 26 is configured to determine an engagement metric for an area of interest. The engagement determination system 26 can be configured to combine a dwell time for each detected person and a person count to generate the engagement metric. For example, in a retail environment, individuals that spend a greater amount of time within an area of interest have a higher engagement with features of the area of interest while individuals with low dwell times, e.g., individuals traveling from a first point outside the area of interest to a second point outside the area of interest, have lower or no engagement with the features of the area of interest.

In some embodiments, the engagement determination system 26 is configured to apply clustering for two or more physical environments to generate an aggregate engagement metric. A clustering model and/or clustering technique can be applied to identify physical environments having similar features or characteristics. For example, in embodiments including retail environments, clustering can be performed based on features including, but not limited to, location (e.g., latitude, longitude, zip code, etc.), retail metrics (e.g., monthly transactions, monthly revenue, etc.), time-series parameters related to operation of the retail environments, etc. Although specific embodiments are discussed herein, it will be appreciated that any suitable features can be used for clustering of physical environments. In some embodiments, the engagement determination system 26 is configured to aggregate processed image data received from two or more clustered physical environments and generates an aggregated engagement metric for the combined physical environments. In some embodiments, the engagement determination system 26 is configured to estimate engagement metrics for one or more physical environments within a cluster based on calculated metrics for one or more other physical environments within the cluster.

In various embodiments, the system or components thereof can comprise or include various modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-module or sub-engine, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

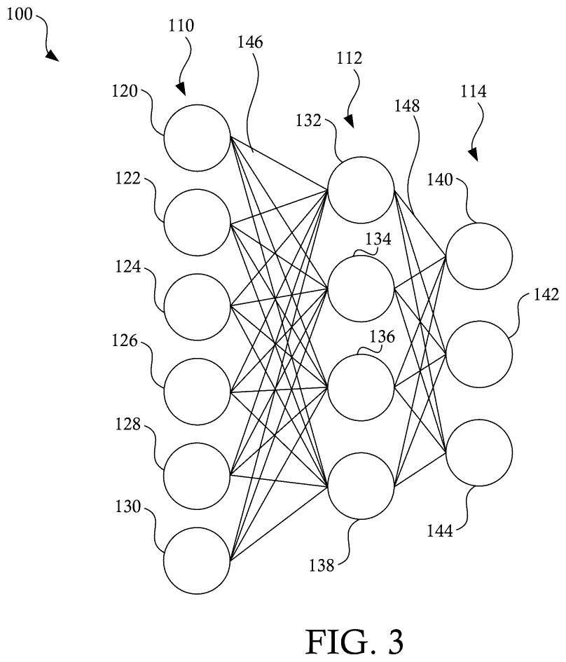

FIG. 3 illustrates an artificial neural network 100, in accordance with some embodiments. Alternative terms for “artificial neural network” are “neural network,” “artificial neural net,” “neural net,” or “trained function.” The neural network 100 comprises nodes 120-144 and edges 146-148, wherein each edge 146-148 is a directed connection from a first node 120-138 to a second node 132-144. In general, the first node 120-138 and the second node 132-144 are different nodes, although it is also possible that the first node 120-138 and the second node 132-144 are identical. For example, in FIG. 3 the edge 146 is a directed connection from the node 120 to the node 132, and the edge 148 is a directed connection from the node 132 to the node 140. An edge 146-148 from a first node 120-138 to a second node 132-144 is also denoted as “ingoing edge” for the second node 132-144 and as “outgoing edge” for the first node 120-138.

The nodes 120-144 of the neural network 100 can be arranged in layers 110-114, wherein the layers can comprise an intrinsic order introduced by the edges 146-148 between the nodes 120-144. In particular, edges 146-148 can exist only between neighboring layers of nodes. In the illustrated embodiment, there is an input layer 110 comprising only nodes 120-130 without an incoming edge, an output layer 114 comprising only nodes 140-144 without outgoing edges, and a hidden layer 112 in-between the input layer 110 and the output layer 114. In general, the number of hidden layer 112 can be chosen arbitrarily and/or through training. The number of nodes 120-130 within the input layer 110 usually relates to the number of input values of the neural network, and the number of nodes 140-144 within the output layer 114 usually relates to the number of output values of the neural network.

In particular, a (real) number can be assigned as a value to every node 120-144 of the neural network 100. Here, xᵢ⁽ⁿ⁾ denotes the value of the i-th node 120-144 of the n-th layer 110-114. The values of the nodes 120-130 of the input layer 110 are equivalent to the input values of the neural network 100, the values of the nodes 140-144 of the output layer 114 are equivalent to the output value of the neural network 100. Furthermore, each edge 146-148 can comprise a weight being a real number, in particular, the weight is a real number within the interval [−1, 1], within the interval [0, 1], and/or within any other suitable interval. Here, w_{i,j}^{(m,n)} denotes the weight of the edge between the i-th node 120-138 of the m-th layer 110, 112 and the j-th node 132-144 of the n-th layer 112, 114. Furthermore, the abbreviation w_{i,j}⁽ⁿ⁾ is defined for the weight w_{i,j}^{(n,m+1)}.

In particular, to calculate the output values of the neural network 100, the input values are propagated through the neural network. In particular, the values of the nodes 132-144 of the (n+1)-th layer 112, 114 can be calculated based on the values of the nodes 120-138 of the n-th layer 110, 112 by

$${x}_{j}^{( n + 1 )} = f ( {\sum }_{i} {x}_{i}^{( n )} \cdot {w}_{i , j}^{( n )} )$$

Herein, the function f is a transfer function (another term is “activation function”). Known transfer functions are step functions, sigmoid function (e.g., the logistic function, the generalized logistic function, the hyperbolic tangent, the Arctangent function, the error function, the smooth step function) or rectifier functions. The transfer function is mainly used for normalization purposes.

In particular, the values are propagated layer-wise through the neural network, wherein values of the input layer 110 are given by the input of the neural network 100, wherein values of the hidden layer(s) 112 can be calculated based on the values of the input layer 110 of the neural network and/or based on the values of a prior hidden layer, etc.

In order to set the values w_{i,j}^{(m,n)} for the edges, the neural network 100 has to be trained using training data. In particular, training data comprises training input data and training output data. For a training step, the neural network 100 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 100 (backpropagation algorithm). In particular, the weights are changed according to

$${w}_{i , j}^{′ ( n )} = {w}_{i , j}^{( n )} - γ \cdot {δ}_{j}^{( n )} \cdot {x}_{i}^{( n )}$$

wherein γ is a learning rate, and the numbers δⱼ⁽ⁿ⁾ can be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( n )} )$$

based on δⱼ⁽ⁿ⁺¹⁾, if the (n+1)-th layer is not the output layer, and

$${δ}_{j}^{( n )} = ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( n )} )$$

if the (n+1)-th layer is the output layer 114, wherein f′ is the first derivative of the activation function, and yⱼ⁽ⁿ⁺¹⁾ is the comparison training value for the j-th node of the output layer 114.

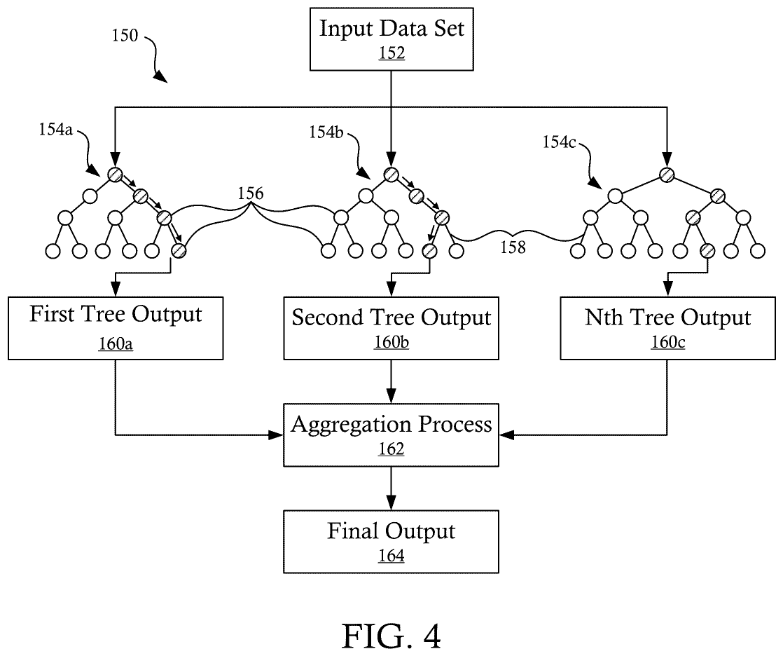

FIG. 4 illustrates a tree-based neural network 150, in accordance with some embodiments. In particular, the tree-based neural network 150 is a random forest neural network, though it will be appreciated that the discussion herein is applicable to other decision tree neural networks. The tree-based neural network 150 includes a plurality of trained decision trees 154a-154c each including a set of nodes 156 (also referred to as “leaves”) and a set of edges 158 (also referred to as “branches”).

Each of the trained decision trees 154a-154c can include a classification and/or a regression tree (CART). Classification trees include a tree model in which a target variable can take a discrete set of values, e.g., can be classified as one of a set of values. In classification trees, each leaf 156 represents class labels and each of the branches 158 represents conjunctions of features that connect the class labels. Regression trees include a tree model in which the target variable can take continuous values (e.g., a real number value).

In operation, an input data set 152 including one or more features or attributes is received. A subset of the input data set 152 is provided to each of the trained decision trees 154a-154c. The subset can include a portion of and/or all of the features or attributes included in the input data set 152. Each of the trained decision trees 154a-154c is trained to receive the subset of the input data set 152 and generate a tree output value 160a-160c, such as a classification or regression output. The individual tree output value 160a-160c is determined by traversing the trained decision trees 154a-154c to arrive at a final leaf (or node) 156.

In some embodiments, the tree-based neural network 150 applies an aggregation process 162 to combine the output of each of the trained decision trees 154a-154c into a final output 164. For example, in embodiments including classification trees, the tree-based neural network 150 can apply a majority-voting process to identify a classification selected by the majority of the trained decision trees 154a-154c. As another example, in embodiments including regression trees, the tree-based neural network 150 can apply an average, mean, and/or other mathematical process to generate a composite output of the trained decision trees. The final output 164 is provided as an output of the tree-based neural network 150.

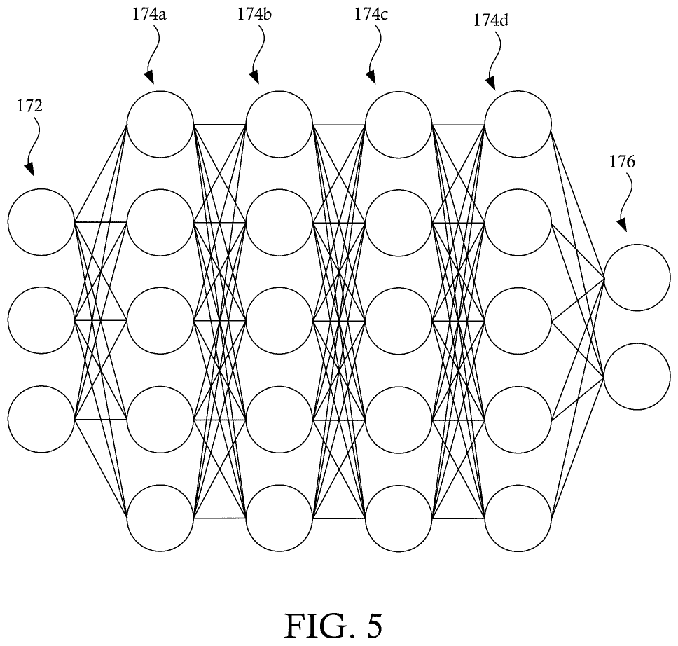

FIG. 5 illustrates a deep neural network (DNN) 170, in accordance with some embodiments. The DNN 170 is an artificial neural network, such as the neural network 100 illustrated in conjunction with FIG. 3, that includes representation learning. The DNN 170 can include an unbounded number of (e.g., two or more) intermediate layers 174a-174d each of a bounded size (e.g., having a predetermined number of nodes), providing for practical application and optimized implementation of a universal classifier. Each of the layers 174a-174d can be heterogenous. The DNN 170 can is configured to model complex, non-linear relationships. Intermediate layers, such as intermediate layer 174c, can provide compositions of features from lower layers, such as layers 174a, 174b, providing for modeling of complex data.

In some embodiments, the DNN 170 can be considered a stacked neural network including multiple layers each configured to execute one or more computations. The computation for a network with L hidden layers can be denoted as:

$$f ( x ) = f [ {a}^{( L + 1 )} ( {h}^{( L )} ( {a}^{( L )} ( … ( {h}^{( 2 )} ( {a}^{( 2 )} ( {h}^{( 1 )} ( {a}^{( 1 )} ( x ) ) ) ) ) ) ) ) ]$$

where α^{(l)}(x) is a preactivation function and h^{(l)}(x) is a hidden-layer activation function providing the output of each hidden layer. The preactivation function α^{(l)}(x) can include a linear operation with matrix W^{(l)} and bias b^{(l)}, where:

$${a}^{( l )} ( x ) = {W}^{( l )} x + {b}^{( l )}$$

In some embodiments, the DNN 170 is a feedforward network in which data flows from an input layer 172 to an output layer 176 without looping back through any layers. In some embodiments, the DNN 170 can include a backpropagation network in which the output of at least one hidden layer is provided, e.g., propagated, to a prior hidden layer. The DNN 170 can include any suitable neural network, such as a self-organizing neural network, a recurrent neural network, a convolutional neural network, a modular neural network, and/or any other suitable neural network.

In some embodiments, a DNN 170 can include a neural additive model (NAM). An NAM includes a linear combination of networks, each of which attends to (e.g., provides a calculation regarding) a single input feature. For example, an NAM can be represented as:

$$y = β + {f}_{1} ( {x}_{1} ) + {f}_{2} ( {x}_{2} ) + … + {f}_{K} ( {x}_{K} )$$

where β is an offset and each fᵢ is parametrized by a neural network. In some embodiments, the DNN 170 can include a neural multiplicative model (NMM), including a multiplicative form for the NAM mode using a log transformation of the dependent variable y and the independent variable x:

y=e^{β}e^{f(logx)}e^{Σ}^{ᵢ}^{f}^{ᵢ}^{^{d}}^{(d}^{ᵢ}⁾

where d represents one or more features of the independent variable x.

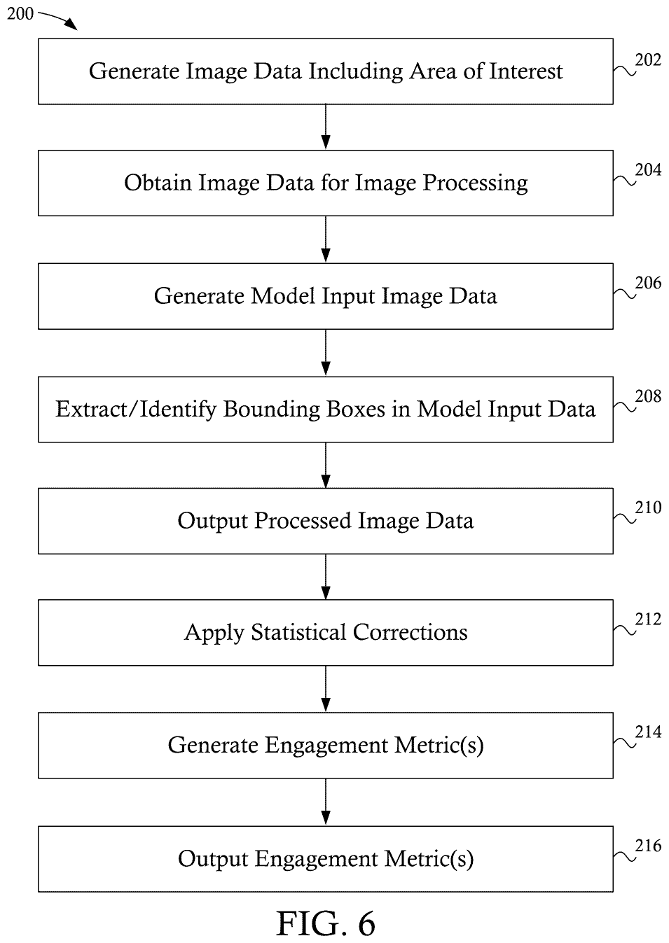

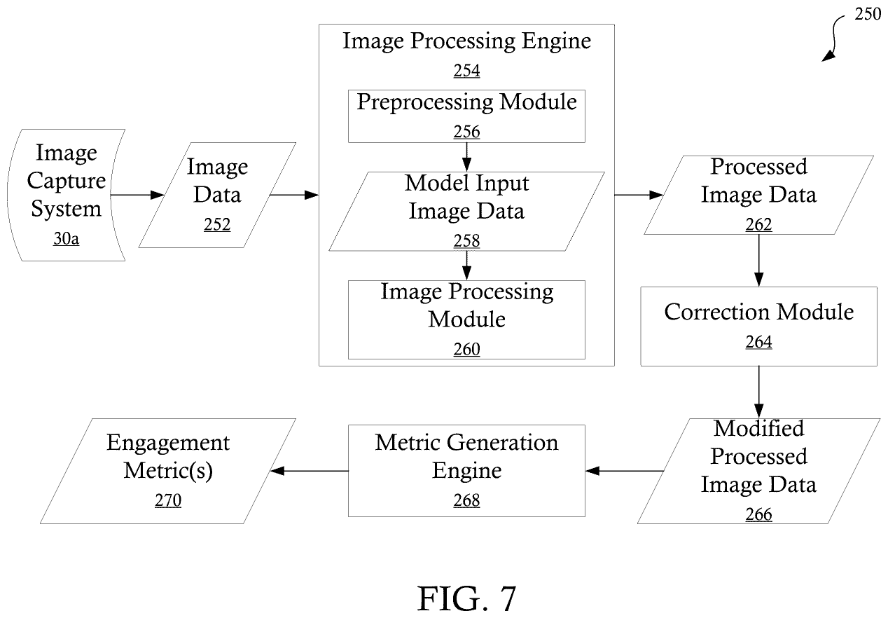

FIG. 6 is a flowchart illustrating a method 200 of engagement determination utilizing computer-vision derived dwell times, in accordance with some embodiments. FIG. 7 is a process flow 250 illustrating various steps of the method of engagement determination utilizing computer-vision derived dwell times, in accordance with some embodiments. At step 202, one or more image capture devices, such as image capture device 22a, generate image data 252 for a portion of a physical environment including one or more areas of interest, such as physical environment 30 including a first area of interest 34a. The image data 252 can include still and/or continuous image data within a FOV 32a of the image capture device 22a.

In some embodiments, the area of interest 34a within the physical environment 30 includes one or more engagement features or elements 36. An engagement feature can include any structure, display, fixture, and/or other element that includes items or content intended for consumption by one or more persons located within the area of interest 34a. For example, in the context of a retail environment, engagement features can include, but are not limited to, visual engagement features such as signage (e.g., analog signage, digital signage, etc.), product displays (e.g., products arranged in a predetermined manner such as televisions mounted to a wall (referred to herein as a “TV wall,”), fixtures containing specific items, and/or other product displays), structural elements, etc., audible engagement features such as audio signage (e.g., announcements, audio generated in conjunction with digital signage), etc., and/or any other type of engagement feature. In some embodiments, the engagement feature can include multiple combined engagement features, such as, for example, a TV wall configured to display digital signage (such as digital advertisements) with or without accompanying generated audio. Although embodiments are discussed herein in the context of a retail environment, it will be appreciated that any suitable engagement features can be defined for any physical environment.

The physical environment 30 is configured to allow movement of one or more persons through the area of interest 34a and, similarly, through the FOV 32a of the image capture device 22a. In some embodiments, the image capture device 22a can be configured to obtain image data 252 having a predetermined length (e.g., 30 seconds, 1 minute, 2 minutes, 5 minutes, etc.) at a preset interval (e.g., 5 minutes, 10 minutes, 30 minutes, one hour, etc.). For example, in some embodiments, an image capture device 22a can be configured to obtain a 1 minute segment of image data every 30 minutes, a 5 minute segment of image data every 30 minutes, a 5 minute segment of image data every hour, etc. It will be appreciated that the predetermined length and the preset interval can be adjusted to provide an accurate estimate of one or more values, e.g. dwell time, person count, engagement metrics, etc. utilizing the disclosed methods, while reducing the overall cost and processing expenditures for the method 200 as compared to continuous monitoring and processing. Although specific embodiments are disclosed herein, it will be appreciated that any suitable segment time and/or interval time, including continuous capture and processing, can be used to obtain and process image data 252.

In some embodiments, the image data 252 can be provided from the image capture device 22a to one or more storage elements. For example, in some embodiments, image data 252 can be provided to a storage queue to store the image data 252 in an image database 28 or other storage elements for later retrieval. In some embodiments, the image data 252 is provided directly to one or more additional elements, such as the image processing engine 254 discussed below. In some embodiments, the image data 252 can be provided simultaneously and/or sequentially to multiple systems, such as being provided to both the image database 28 and the image processing engine 254.

At step 204, the image data 252 is provided to and/or obtained by an image processing engine 254. The image processing engine 254 can obtain the image data 252 directly from the image capture devices 22a, from a storage element such as the image database 28, and/or from any other suitable source. The image data 252 can be provided in real time (e.g., provided as the image data 252 is generated and transmitted by the image capture device 22a) and/or as a batch process (e.g., obtained at a time separate from generation of the data by the image capture devices 22a). In some embodiments, the image processing engine 254 is configured to execute one or more pipelines for obtaining and processing image data 252.

At step 206, the image data 252 is preprocessed to generate model input image data 258. In some embodiments, a preprocessing module 256 is configured to apply one or more pre-processing techniques to modify the image data 252. For example, in some embodiments, the preprocessing module 256 is configured to apply region of interest (ROI)-based processing. An ROI-based process can be configured to identify portions of the image data 252 that are of interest with respect to the determination of one or more engagement metrics. For example, in some embodiments, the preprocessing module 256 can apply ROI processing to identify an area of interest 34a within image data having a FOV 32a including additional portions of the physical environment 30 outside of the area of interest 34a. As another example, in some embodiments, an ROI-based process can be configured to perform an initial detection of potential persons within the image data 252 and/or the area of interest 34a. As yet another example, in some embodiments, the preprocessing module 256 can be configured to apply a blurring and/or other anonymizing process to the image data 252 to remove identifying information, such as facial images, prior to performing additional processing.

As another example, in some embodiments, the image capture device 22a includes a 360° degree view camera that generates images having a 360° degree field of view including barrel distortion. In some embodiments, the preprocessing module 256 is configured to apply a zoom-in crop process to mitigate or remove barrel distortions and/or other camera-specific distortions. The zoom-in crop process is configured to divide the image data 252 into multiple portions (e.g., crops) that contain partially and/or non-overlapping sections of the image data 252.

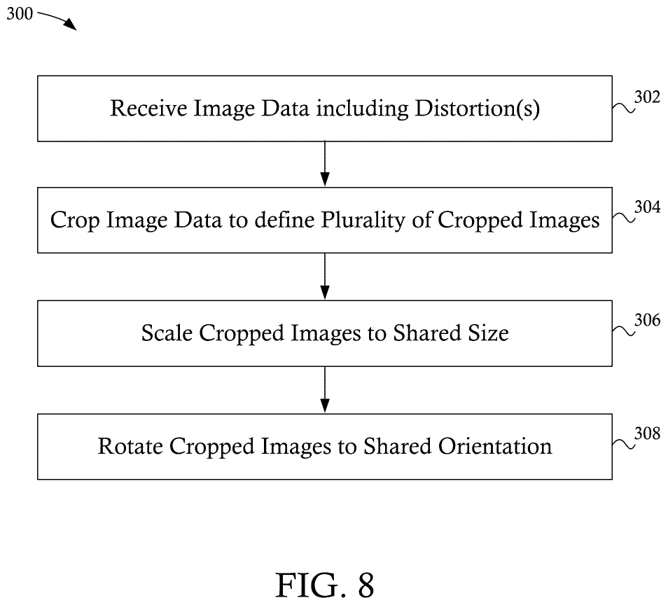

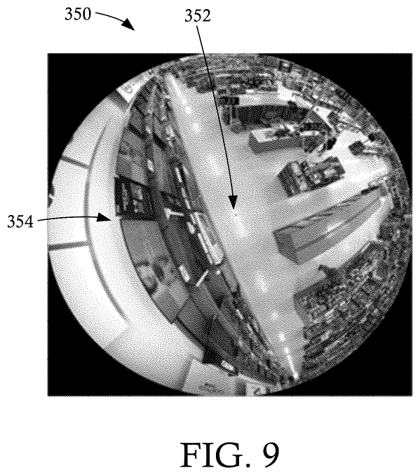

FIG. 8 is a flowchart illustrating a zoom-in crop method 300, in accordance with some embodiments. At step 302, image data 252 including one or more distortions, such as a barrel distortion, is received. FIG. 9 illustrates a 360° image 350 including barrel distortion, in accordance with some embodiments. The 360° image 350 can be obtained, for example, by a 360° view image capture device. As shown in FIG. 9, the 360° image 350 includes a field of view that elongates objects that are farther away from a center point 352 of 360° image 350. In addition, the orientation of objects within the 360° image 350 rotate around the center point 352 such that the same object that is vertical (e.g., substantially aligned along a Y-axis) in a first portion of the 360° image 350 would be horizontal (e.g., substantially aligned along the X-axis) or off-axis (e.g., not substantially aligned on either the X-axis or the Y-axis) in a second portion of the 360° image 350. Distortions generated by the image capture device 22a, such as elongation and rotation of objects within the 360° image 350, can introduce additional challenges for image processing.

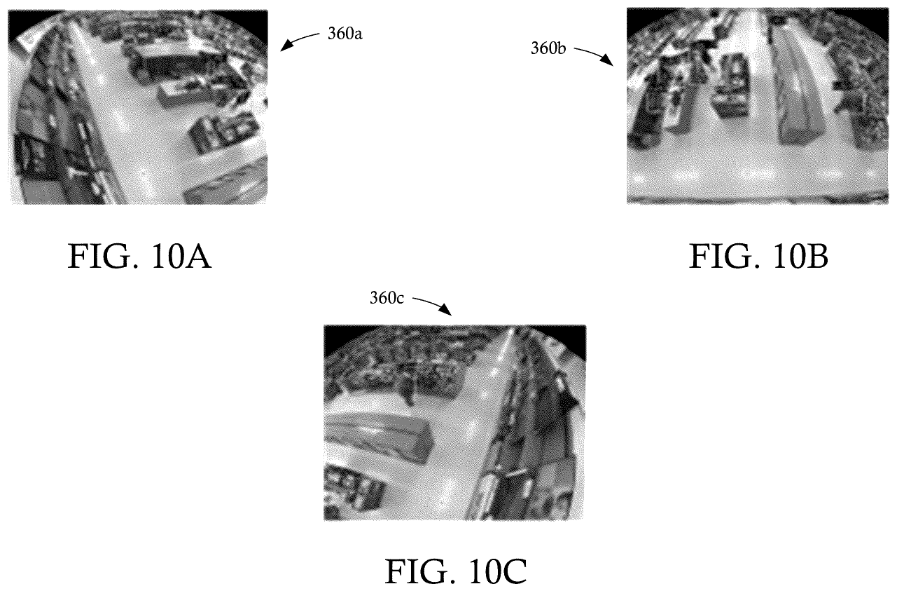

At step 304, the image data 252, such as the 360° image 350, is cropped or partitioned. In some embodiments, the preprocessing module 256 is configured to apply predetermined crops or cropping boundaries to the image data 252 to define a set of cropped images. For example, the 360° image 350 of FIG. 9 can be cropped to generate a set of two or more cropped images defining predetermined portions of the 360° image 350. FIGS. 10A-10C illustrate a set of cropped images 360a-360c generated from the 360° image 350, in accordance with some embodiments. As shown in FIGS. 10A-10C, the cropped images 360a-360c can each include an overlapping portion 362 of the 360° image 350 containing a walking area 352 adjacent to a TV wall 354. In addition, each cropped image 360a-360c includes a unique portion 364a-364c that is not included in each of the other cropped images 360a-360c.

At optional step 306, the cropped portions of the image data 252 can be scaled to similar dimensions. For example, in some embodiments, a first cropped image obtained in a first orientation and centered around a center point of an image, such as a 360° image 350, can have a first size (e.g., a first number of horizontal and vertical pixels) without substantial barrel or other distortions being included. However, a second cropped image obtained in a second orientation and/or not centered around a center point of an image may include substantial distortions if obtained at the first size. In such embodiments, a cropped image of a second, smaller size can be obtained for the second cropped image and subsequently scaled to be of similar size to the first cropped image (or, alternatively, the first cropped image can be scaled to size of the second cropped image). The process of obtaining a smaller portion of an image and scaling to a similar size as other portions of an image is referred to herein as a “zoom-in” process.

At step 308, one or more of the cropped portions of the image data 252 are rotated such that each of the cropped portions has a similar orientation. For example, as illustrated in FIGS. 10A-10C, each of the cropped images 360a-360c is rotated from an original orientation (see FIG. 9) to an orientation in which objects and individuals in the image are vertical and oriented so that a top portion of the objects and individuals are towards a top edge of the cropped image 360a-360c.

In some embodiments, the zoom-in crop method 300 can generate consistent, simplified images, e.g. cropped images 360a-360c, for use image processing, but can introduce additional errors or constraints, for example, resulting in an increase in false positives during image processing. In order to reduce errors introduced by a zoom-in crop process, in some embodiments, the preprocessing module 256 is configured to apply a frame differencing process to the cropped images. The frame differencing process is configured to reduce static (e.g., non-moving object) false positives and/or other errors introduced by the zoom-in crop process and/or the image capture process.

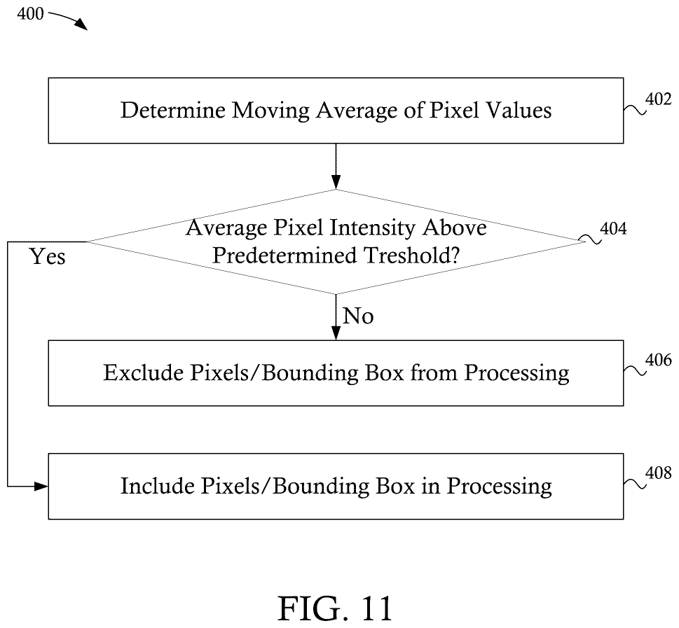

FIG. 11 is a flowchart illustrating a frame differencing method 400, in accordance with some embodiments. At step 402, a moving average of pixel values for portions of the image data 252 is determined. For example, in some embodiments, a moving average of pixel values for overlapping cropped portions of the image data 252 can be generated. In some embodiments, the frame differencing method 400 can be applied to extracted bounding boxes (discussed with respect to step 208 below). The moving average the moving average image R for a pixel defined by coordinates x, y, z at time t can be provided by the equation:

$$R ( x , y , z , t ) = ( 1 - α ) {\sum }_{τ = - ∞}^{t} {α}^{t - τ} I ( x , y , z , τ )$$

where I is the image at the pixel defined by coordinates x, y, z at time t, τ is a running variable over past iterations where past τ∈[−∞, t], α is a variable denoting the frequency of change for the area of interest and/or frequency of movement for subjects of interest within the area of interest.

At step 404, the average pixel intensity difference between the moving average image R and a current image for a portion of the image data 252 is determined. When the average difference in pixel intensities is less than, or in some embodiments equal to, a predetermined threshold, the corresponding pixels are considered representative of a static (e.g., stationary) object and the method proceeds to step 406. At step 406, the current image portion is excluded from the image processing method. When the average difference in pixel intensities is greater than or, in some embodiments, equal to, a predetermined threshold, the corresponding pixels are considered representative of a moving, e.g., detected, object and the object detection is included in the image processing method. For example, if the frame differencing method 400 is applied to extracted bounding boxes, the detection for that bounding box can be removed from the list of generated detections when the average difference is below a predetermined threshold and kept in the list of generated directions when the average difference is above a predetermined threshold.

In some embodiments, non-image data can be utilized to perform preprocessing of the image data 252. For example, in some embodiments, distance information corresponding to the position, relative distances, etc. of static objects in the image data 252 can be utilized. The distance information can be used to perform de-fisheye pre-processing and/or the generation of a homograph matrix for projecting an image view to a second, properly dimensioned view, such as view included in a blueprint, floorplan, etc.

At step 208, one or more person bounding boxes are extracted from the model input image data 258. In some embodiments, the image processing engine 254 is configured to implement at least one image processing model 260, such as, an object detection model, a person detection model, etc., configured to apply a trained model framework for person detection. The at least one image processing model 260 can include any suitable model framework, such as, for example, a deep learning framework. In some embodiments, the image processing model 260 includes a trained YOLO model (such as a YOLO5 model) configured for person detection. As discussed in greater detail below, in some embodiments, the image processing model 260 is generated, in part, utilizing a human-in-the-loop (HITL) process.

At step 210, processed image data 262 including a total person count and individual dwell times is generated. In some embodiments, the image processing model 260 is configured to apply one or more trajectory estimation, tracking, and/or other computer-vision processes to the extracted person bounding boxes to determine a person count for the image data 252. For example, in some embodiments, for each detected person bounding box, the image processing model 260 applies a trajectory estimation, such as frame stitching, to predict a trajectory of the detected person through the image data 252. The image processing model 260 utilizes the trajectory estimation to determine entry and exit events for each detected person in the image data 252. For example, a person count can be incremented for each entry event within an area of interest 34a. In some embodiments, the image processing model 260 is configured to apply an estimated trajectory to exclude individuals who do not pass within a predetermined area of interest within the image data 252. In some embodiments, the image processing model 260 includes a trained trajectory model, such as a DeepSORT model, configured to perform trajectory estimation.

As another example, in some embodiments, for each identified person bounding box, the image processing model 260 applies a dwell time count to determine the total amount of time that a detected individual is within an area of interest in the image data 252. The dwell time can be determined based on the entry and exit events for each person (e.g., each bounding box) and time data corresponding to the time difference between the entry and exit events for the given bounding box. The time data can be provided with the image data 252 (e.g., variables such as real-time stamps or relative time stamps indicating time values for the image data such as start time, end time, total recording time, individual frame time, etc.), and/or can be calculated based on a total number of frames between the entry event and the exit event and a frame rate of the image data 252 (e.g., if an entry event is separated from an exit event by six frames and the frame rate is 3 frames per second, the total dwell time is 2 seconds). Although specific embodiments are discussed herein, it will be appreciated that any suitable process can be utilized to determine dwell time of a detected individual and/or bounding box within the image data 252.

In some embodiments, the image processing model 260 is configured to apply one or more postprocessing methods prior to and/or simultaneously with generation of the processed image data 262. For example, in some embodiments, the image processing model 260 can apply a non-maximal suppression process to remove duplicate detections across two or more crops. As discussed above, a zoom-in crop process can generate cropped portions of the image data 252, such as cropped images 360a-360c, that include at least partially overlapping fields of view. In such embodiments, the same individual can appear in multiple cropped portions of the image data 252 and counted multiple times. In order to reduce multiple counting of the same individual and/or bounding box, the image processing model 260 can apply non-maximal suppression, which selects one of (e.g. a best) bounding box for a set of overlapping bounding boxes. Additional postprocessing techniques can be applied prior to and/or in conjunction with generation of the processed image data 262.

Although steps 206-210 are illustrated and discussed sequentially, it will be appreciated that the preprocessing applied at step 206 can be performed prior to, simultaneously to, and/or after the bounding box extraction at step 208. Similarly, it will be appreciated that the generation of at least a portion of the processed image data 262 discussed at step 210 can occur prior to, simultaneously with, and/or after the preprocessing and bounding box extraction. As one example, in some embodiments, frame differencing can be applied to extracted bounding boxes generated at step 208 prior to and/or simultaneously with generation of the person count at step 210. In addition, although embodiments are discussed herein including a preprocessing module 256 configured to generate model input image data 258 that is provided to an image processing model 260, it will be appreciated that the preprocessing module 256 and the image processing model 260 can be partially and/or completely combined into a single trained model configured to perform portions of and/or all of each of steps 206-210. Additional combinations and/or modifications of the illustrated system components and method steps will be apparent to those of skill in the art.

In some embodiments, a person count generated by the image processing engine 254 can overcount the number of persons (e.g., the number of daily impressions) due to one or more factors, such as occlusions obstructing portions of the physical environment within the image data 252 resulting in an individual exiting and re-entering the field of view of an image capture device 22a, 22b (and being counted as two separate individuals), the presence of individuals to be excluded from a count (e.g., in a retail environment, retail employees can be excluded from a person count when determining engagement of a population of customers), the placement of image capture devices 22a, 22b (e.g., detection of individuals within regions outside of the area of interest), etc. In some embodiments, at optional step 212, one or more statistical corrections can be applied to the generated person count to correct for potential overcounting.

For example, in some embodiments, a correction module 264 can generate a predicted person count for the image data 252. The predicted person count P for a portion of the image data 252 (“video chunk”) can be determined as:

$$P ( video chunk ) = s {\sum }_{i = 0}^{n} ( d [ i ] > c )$$

where s is a scaling factor, d[i] is a dwell time for a bounding box within the video chunk, and c is a dwelling cutoff factor. In some embodiments, the scaling factor s and the dwelling cutoff factor c can include hyperparameters generated by a machine learning process. For example, in some embodiments, the scaling factor s and the dwelling cutoff factor c can be generated by determining an actual count of persons within a plurality of video chunks, calculating a predicted persons count according to the above equation (for example, utilizing initial values for s and c, and iteratively modifying (e.g. regressing) s and c based on a minimum mean squared error (MMSE) criteria.

After training, the scaling factor s and the dwelling cutoff factor c can be utilized to determine the predicted person count P for the video chunk. The predicted person count can be utilized in place of actual count of individuals in a video chunk when calculating one or more engagement metrics, as discussed in greater detail below. In some embodiments, the predicted person count and/or other values can be used to scale the actual person count. The scaled value can be utilized in place of an actual count of individuals or a predicted count of individuals to determine one or more engagement metrics. In some embodiments, the modified person count (e.g., predicted person count, scaled person count, etc.) can be output as modified processed image data 266. In some embodiments, the use of statistical corrections as disclosed herein can eliminate the need for ROI filtering to detect potential persons in the image data 252 during a preprocessing stage, although it will be appreciated that ROI can still be performed in conjunction with statistical corrections.

At step 214, at least one engagement metric 270 is generated. For example, in some embodiments, a metric generation engine 268 is configured to receive the processed image data 262 and/or the modified processed image data 266 and generate at least one engagement metric 270. The metric generation engine 268 can be configured to apply any suitable metric generation process. For example, in some embodiments, the metric generation engine 268 includes one or more modules configured to combine (e.g., fuse) a dwelling time and person count to generate an engagement estimation. The amount of time spent within a predetermined area including one or more engagement features (for example, the amount of time spent near a TV wall) is related to the level of engagement with the engagement features, for example, with a higher dwell time having a higher engagement and a lower dwell time having a lower engagement.

In some embodiments, the engagement estimation is generated by a trained engagement model based on the equation:

$$E = s * {\sum }_{x = 0}^{P} [ 1 + \frac{d ( x )}{{t}_{e}} ] I ( d ( x ) > {d}_{c} )$$

where E is an engagement score for the image data (e.g., a predetermined portion of image data 252, such as a video chunk), s is the scaling factor and d_{c} is the dwell time factor determined according to the statistical correction discussed above with respect to step 212, d(x) is a dwell time for the x^{th} person in the image data 252, P is the person count for the image data 252 (e.g., actual person count, predicted person count, scaled person count, etc.), I is an indicator function which is equal to 1 if the condition d(x)>d_{c} is true and otherwise is equal to 0, and tₑ is a constant indicating the frequency of an engagement feature within the area of interest. For example, in some embodiments, the engagement feature includes digital content, such as video content or digital signage content, that is displayed at a given interval or frequency tₑ. In some embodiments, tₑ can be selected based on a minimum time slot repetition for the engagement feature. In some embodiments, the at least one engagement metric 270 includes an impression per play value (e.g., a value representative of the number of impressions per each time a corresponding engagement feature is displayed within the area of interest).

In some embodiments, the metric generation engine 268 is configured to incorporate additional, non-image data for engagement estimation. For example, in some embodiments, the metric generation engine 268 is configured to include distance information including known to distances of objects included within the image data 252, The distance information can include any suitable distance information, such as, for example, layout (e.g., blueprints, floor plans, etc.) of the physical environment 30 including distance measurements for static objects within the image data 252. In some embodiments, the engagement estimation can be performed according to the equation:

$$E = s * {\sum }_{x = 0}^{P} [ 1 + \frac{{\sum }_{t = t\_start}^{t\_end} {e}^{- \frac{{dist}_{x} ( t )}{C}}}{300} ] I ( d ( x ) > {d}_{c} )$$

where distₓ(t) identifies the distance of a trajectory of the x^{th} person from a fixed point (e.g., an engagement feature) within the image data 252 and C is a hyperparameter constant generated during training of a corresponding engagement model.

At step 216, the at least one engagement metric 270 can be output from the metric generation engine 268 and provided to one or more systems for further processing. For example, in some embodiments, the at least one engagement metric 270 is included in a user interface generated and provided to one or more users for review. As another example, in some embodiments, the at least one engagement metric 270 can be utilized to determine values related to the display of engagement features within the area of interest, such as determining pricing for engagement features within the area of interest, allocation of metrics (e.g., revenue) to each of the engagement features within the area of interest, etc. In some embodiments, the at least one engagement metric 270 can be combined with engagement feature metadata by one or more automated processes to generate one or more values related to the display of engagement features within the area of interest.

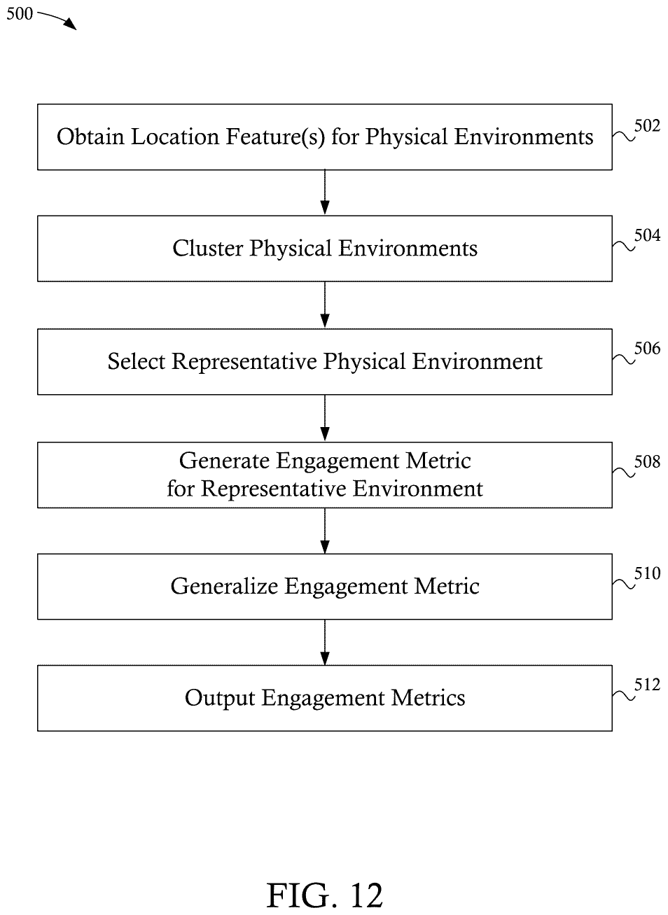

In some embodiments, the at least one engagement metric 270 generated for a first physical environment 30 can be used to estimate engagement for one or more additional physical environments. FIG. 12 illustrates a method 500 of generalizing at least one engagement metric 270 for a first physical environment to one or more additional physical environments, in accordance with some embodiments. At step 502, a set of location features is obtained for each of a plurality of physical environments. For example, in some embodiments, the plurality of physical environments include a plurality of retail locations and the set of location features obtained for each of the retail locations includes location data (e.g., latitude, longitude, zip code, predefined geographic zones, etc.), time-series data related to operation of each retail location, such as monthly transaction data, traffic data, etc., demographic data, and/or any other suitable features. In some embodiments, the set of location features includes intrinsic timeseries characteristics. Although specific embodiments are discussed herein, it will be appreciated that any suitable set of location features can be obtained for any type of location including one or more engagement features.

At step 504, the plurality of physical environments are clustered. For example, in some embodiments, a trained clustering model is applied based on the location features to generate a set of clustered physical environments. The trained clustering model can be configured to apply one or more clustering and/or mixed integer programming techniques, such as agglomerative clustering, to generate the set of clustered physical environments. The trained clustering model can include any suitable model framework, such as, for example, a density-based model (e.g., Density-Based Spatial Clustering of Application with Noise (DBSCAN), Ordering Points to Identify Clustering Structure (OPTICS), etc.), a hierarchical based model including agglomerative clustering or divisive clustering (e.g., Clustering Using Representatives (CURE), Balanced Iterative Reducing Clustering and using Hierarchies (BIRCH), etc.), partitioning models (e.g., K-means, Clustering Large Applications based upon Random Search (CLARANS), etc.), grid-based methods (e.g., Statistical Information Grid (STING), wave cluster, Clustering in Quest (CLIQUE), etc.), and/or any other suitable clustering technique. In some embodiments, a trained clustering model is generated by an iterative training process including a HITL process configured to generate person count values across multiple environments.

At step 506, at least one representative environment is selected from each cluster in the set of clusters. The at least one representative environment can be selected randomly and/or based on one or more criteria. For example, in some embodiments, the at least one representative environment can be selected for each cluster based on a constrained optimization problem to provide coverage over certain selected variables for each environment, such as providing coverage of different time-zones, location representations, location types, etc.

At step 508, at least one engagement metric 270 is generated for each of the selected representative environments. The at least one engagement metric 270 can be generated, for example, according to the method 200 of engagement determination utilizing computer-vision derived dwell times discussed above. Although specific embodiments are discussed herein, it will be appreciated that the disclosed method 500 can be used to generalize engagement metrics generated according to any suitable process to additional physical environments.

At step 510, the at least one engagement metric 270 for the selected representative environment is generalized to the remaining environments within a corresponding cluster of locations. Generalization to the additional locations in a cluster can be based on one or more time-series features. For example, in the context of retail locations, an engagement metric 270 can be generalized utilizing time-series features such as transactions, units sold, and/or other time series values related to the retail locations aggregated over a predetermined time period, for example, daily, weekly, etc.

In some embodiments, generalization of the at least one engagement metric 270 can be performed by a trained model, such as, for example, a trained regression model. For example, in some embodiments, a trained regression model can be configured to apply an auto regression defined by:

$$y ( t ) = {\sum }_{k = 0}^{p 1} α ( k ) T ( t - k ) + {\sum }_{k = 0}^{p 2} β ( k ) C ( t - k ) + {\sum }_{k = 1}^{p 3} γ ( k ) \hat{y} ( t - k ) + {ϵ}_{t}$$

where y(t) is the a predicted time series representative of the at least one engagement metric 270 for an additional location, T is a selected time-series feature (e.g., transactions, units sold, etc.), C is a nearest cluster medoid time series (e.g., the engagement metric 270 represented as a time-series for the selected representative environment), and α(k), β(k), γ(k) are regression parameters generated during iterative training of the model. In some embodiments, the trained regression model is generated by an iterative training process based on actual and predicted time-series values for the at least one engagement metric 270.

At step 512, an estimated (e.g., inferred) engagement metric, e.g., the time-series y(t), is output for each additional environment in a cluster. The estimated engagement metric for each additional environment can be utilized similar to the engagement metric 270 determined for the representative environment, as discussed above.

The disclosed systems and methods, e.g., the disclosed method 200 of engagement determination utilizing computer-vision derived dwell times and the disclosed method 500 of generalizing at least one engagement metric, reduce detection inaccuracies and provide accurate generalization over multiple physical environments. For example, the disclosed systems and methods can provide an improvement to a mean average precision (mAP) and a reduction of log average miss rate for person detection within image data 252. For example, in some embodiments, the disclosed systems and methods provide an improvement of over four times mAP percentage and a reduction of log average miss rate percentage over 60% as compared to certain existing baseline models. Similarly, in some embodiments, the disclosed systems and methods provide an improvement of over 4.5 times higher order tracking accuracy for trajectory estimation as compared to certain existing baseline models.

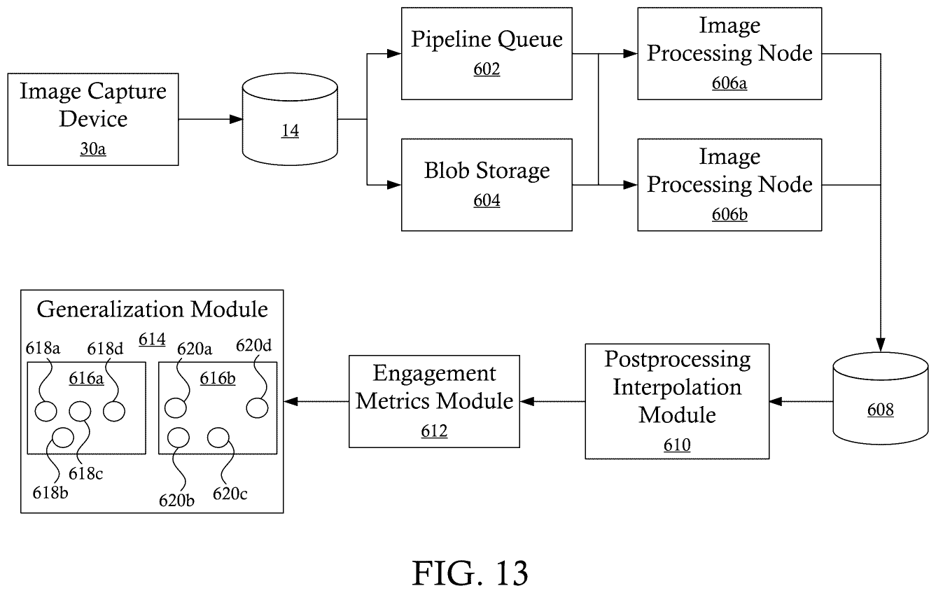

FIG. 13 illustrates an end-to-end pipeline 600 for engagement estimation, in accordance with some embodiments. The end-to-end pipeline 600 includes at least one image capture device 22a positioned within a corresponding physical environment and configured to obtain image data. The image data is provided to at least one storage mechanism, such as an image database 28. The image database 28 is in signal communication with a pipeline queue 602 and blob storage element 604. The pipeline queue 602 and/or the blob storage element 604 are configured to provide the obtained image data to one or more processing nodes 606a-606b. The processing nodes 606a-606b are each configured to implement an image processing method to a first set of processed image data. For example, in the illustrated embodiment, each of the processing nodes 606a-606b is configured to generate entry and exit events for one or more bounding boxes within the image data. Each of the processing nodes 606a-606b can be assigned to process a specific set of image data (e.g., a specific video chunk), a portion of larger image data (e.g., a portion of a video chunk), a specific bounding box, etc.

The first set of processed image data is provided from each of the nodes 606a-606b to an intermediate storage mechanism 608. A post-processing interpolation module 610 is configured to obtain the first set of processed image data from the intermediate storage mechanism and generate a second set of processed image data. For example, in some embodiments, the post-processing interpolation module 610 is configured to generate dwell time values and person counts based on the first set of processed image data. An engagement metrics module 612 is configured to receive the second set of processed image data and generate one or more engagement features for the corresponding physical environment. The processing nodes 606a-606b, intermediate storage mechanism 608, post-processing interpolation module 610, and the engagement metrics module 612 can be configured to collectively implement the method 200 discussed above with respect to FIGS. 6-7.

The end-to-end pipeline includes a generalization module 614 configured to apply a generalization method, such as generalization method 500 discussed above. The generalization module 614 generates a set of clusters 616a, 616b each including a plurality of physical environments 618a-618d, 620a-620d. The physical environment 618a corresponding to the image capture device 22a is selected as a representative location and the generalization module 614 generalizes the at least one engagement metric generated by the engagement metrics module 612 to each of the remaining locations in the corresponding cluster 616a.

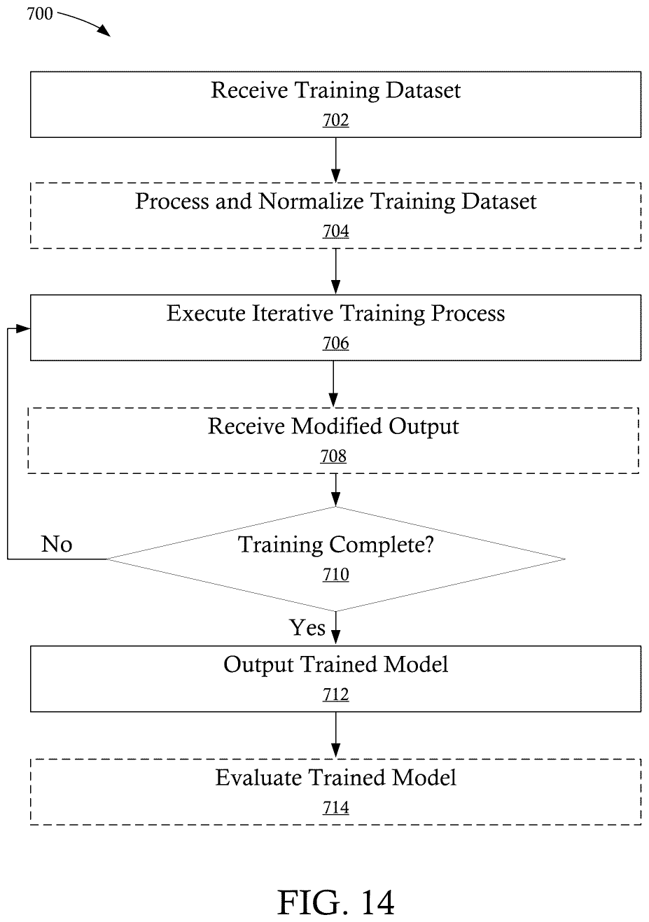

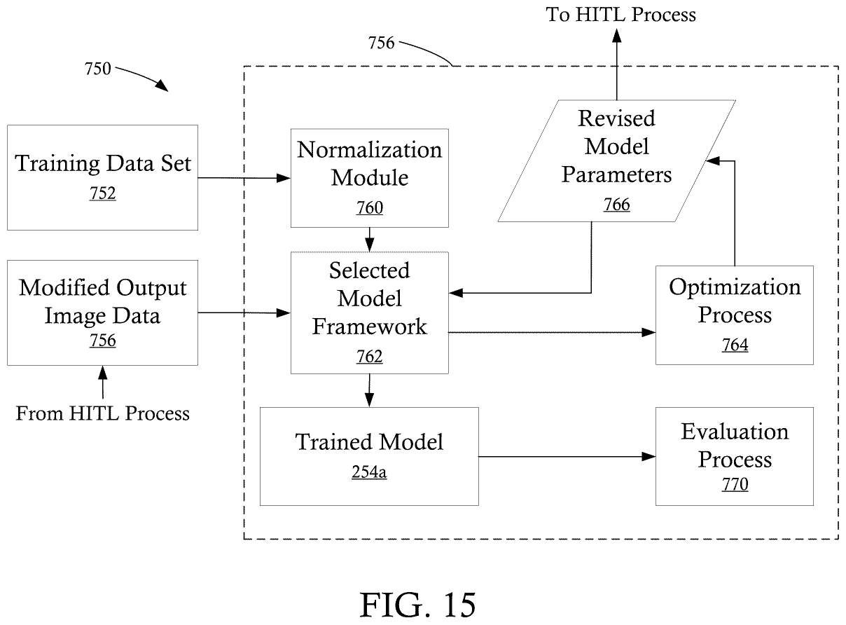

FIG. 14 is a flowchart illustrating a method 700 of generating a trained image processing model, in accordance with some embodiments. FIG. 15 illustrates a process flow 750 of various steps of the method 700, in accordance with some embodiments. At step 702, a training dataset 752 is received. The training dataset 752 can include labeled and/or unlabeled data. For example, in some embodiments, the training dataset 752 includes labeled training data including image data segments having one or more corresponding detected persons. As another example, in some embodiments, the training dataset 752 includes unlabeled training data including image data segments without identification of persons or bounding boxes within the segments.

In some embodiments, the training dataset 752 can include image data obtained from one or more physical environments and/or synthetic training data. Synthetic training data includes artificial data that is configured to mimic real-world data. For example, synthetic training data can include computer-generated image data similar to the image data obtained by one or more image capture devices 22a, 22b that include the area of interest 34a within the FOV 32a.

At optional step 704, the received training dataset 752 is processed and/or normalized by a normalization module 760. For example, in some embodiments, the training dataset 752 can be augmented by modifying image data segments to have similar lengths, frame rates, etc. In some embodiments, processing of the received training dataset 752 includes outlier detection configured to remove data likely to skew training, such as image data segments obtained during specific time periods (e.g., when a physical environment is closed or otherwise not occupied), during specific events (e.g., during periods of unusually high or unusually low traffic for the physical environment) etc. Although specific embodiments are discussed herein, it will be appreciated that any suitable processing can be applied to the training dataset 752.

At step 706, an iterative training process is executed to train a selected model framework 762, for example, by an iterative training engine 756. The selected model framework 762 can include one or more untrained (e.g., base) machine learning model frameworks, such as a deep learning framework (e.g., a YOLO framework) configured to utilize zoom-in crop and frame differencing and/or a deep learning framework (e.g., DeepSORT) configured to utilize frame stitching trajectory estimation. The training process is configured to iteratively adjust parameters (e.g., hyperparameters) of the selected model framework 762 to minimize a cost value (e.g., an output of a cost function) for the selected model framework 762. In some embodiments, the selected model framework 762 is configured to apply a data augmentation processes, such as image rotation and/or mosaic augmentation processes.

The training process is an iterative process that generates set of revised model parameters 766 during each iteration. The set of revised model parameters 766 can be generated by applying an optimization process 764 to the cost function of the selected model framework 762. The optimization process 764 can be configured to reduce the cost value (e.g., reduce the output of the cost function) at each step by adjusting one or more parameters during each iteration of the training process.

In some embodiments, at optional step 708, an output of the selected model framework 762 is modified by a HITL process. For example, in some embodiments, the iterative training process is configured to generate a set of output images including bounding boxes, trajectory information, and/or other relevant image data. The output images are provided, via a display and a user interface, to a user. The user can modify the output images to add, remove, or change bounding boxes, trajectory information, or other relevant image data. The modified output image data 768 generated by through the HITL process is provided to the iterative training engine 756 and utilized as a second set of labeled training data during subsequent iterations of the iterative training process. The HITL process at step 708 can be applied one or more times during the iterative training process.

After each iteration of the training process, at step 710, a determination is made whether the training process is complete. The determination at step 710 can be based on any suitable parameters. For example, in some embodiments, a training process can complete after a predetermined number of iterations. As another example, in some embodiments, a training process can complete when it is determined that the cost function of the selected model framework 762 has reached a minimum, such as a local minimum and/or a global minimum.

At step 712, a trained image processing model 260a is output and provided for use in engagement metric determination method, such as the method 200 discussed above with respect to FIGS. 6-7. The trained image processing model 260a is configured to generate processed image data 262 for calculation of at least one engagement metric 270. At optional step 714, a trained image processing model 260a can be evaluated by an evaluation process 772. Although specific embodiments are discussed herein, it will be appreciated that any suitable set of evaluation metrics can be used to evaluate a trained model.

The disclosed method 700 of generating a trained image processing model is configured to generate trained image processing models (e.g., trained person detection models) that are configured for a specific area of interest within a physical environment. The specifically trained image processing models improve computer-vision processes by reducing or eliminating false positives and providing time and processing improvements. The systems and methods disclosed herein significantly reduce problems associated with computer-vision processing, providing identification of bounding boxes, trajectories, and other related processed image data in a shorter period of time and at a higher accuracy rate. In addition, the systems and methods disclosed herein provided further reductions in time and processing power by applying estimation of metrics across clustered physical environments, eliminating the need to perform image processing and metric determination for substantially similar physical environments.

Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
an image capture device configured to generate image data including an area of interest within a physical environment containing at least one engagement feature;
a non-transitory memory; and
a processor communicatively coupled to the non-transitory memory, wherein the processor is configured to read a set of instructions to:
receive the image data;
generate model input image data including a plurality of cropped images by applying a zoom-in crop process to the image data;
implement an image processing model to generate a person count and dwell time, wherein the image processing model receives the model input image data as an input; and
generate an engagement metric based on the person count and the dwell time, wherein the engagement metric is representative of engagement with the at least one engagement feature.

2. The system of claim 1, wherein the model input image data is generated by applying frame differencing to the plurality of cropped images.

3. The system of claim 1, wherein the processor is configured to implement a regression model to generate a predicted person count, wherein the regression model receives the person count as an input, and wherein the engagement metric is generated based on the predicted person count and the dwell time.

4. The system of claim 1, wherein the engagement metric is generated as a weighted sum of the dwell time over a minimum time slot repetition of the engagement feature for each dwell time greater than a dwell time cutoff and scaled by a scaling factor.

5. The system of claim 1, wherein the physical environment is one or more of a plurality of physical environments, and wherein the processor is configured to:
generate a plurality of clusters, wherein a selected one of the plurality of clusters includes the selected one of the plurality of physical environments and at least one additional physical environment; and
implement a regression model to generate an estimated engagement metric for each of the additional physical environments, wherein the regression model is generated by training data including one or more features of each of the plurality of physical environments, and wherein the regression model receives the engagement metric as an input.

6. The system of claim 1, wherein the engagement metric is a time series metric.

7. The system of claim 1, wherein the image processing model is configured to:
generate one or more bounding boxes corresponding to one or more persons within the image data;
determine a trajectory estimate for each of the one or more bounding boxes;
identify an entry event and an exit event for each of the one or more bounding boxes based on the trajectory estimate; and
output the processed image data based on the entry event and exit event for each of the one or more bounding boxes, wherein the person count is a count of entry events, and wherein the dwell time for each of the one or more bounding boxes is a time difference between the entry event and exit event for each of the one or more bounding boxes.

8. The system of claim 7, wherein the image processing model is configured to apply a region of interest process prior to generating the one or more bounding boxes.

9. The system of claim 1, wherein the image capture device is configured to generate the image data at a predetermined interval, and wherein the image data includes a predetermined length.

10. A computer-implemented method, comprising:
receiving image data from an image capture device, wherein the image data includes an area of interest within a physical environment containing at least one engagement feature;
generating model input image data including a plurality of cropped images by applying a zoom-in crop process to the image data;
implementing an image processing model to generate a person count and dwell time, wherein the image processing model receives the model input image data as an input; and
generating an engagement metric based on the person count and the dwell time, wherein the engagement metric is representative of engagement with the at least one engagement feature.

11. The computer-implemented method of claim 10, wherein the model input image data is generated by applying frame differencing to the plurality of cropped images.

12. The computer-implemented method of claim 10, comprising implementing a regression model to generate a predicted person count, wherein the regression model receives the person count as an input, and wherein the engagement metric is generated based on the predicted person count and the dwell time.

13. The computer-implemented method of claim 10, wherein the engagement metric is generated as a weighted sum of the dwell time over a minimum time slot repetition of the engagement feature for each dwell time greater than a dwell time cutoff and scaled by a scaling factor.

14. The computer-implemented method of claim 10, wherein the physical environment is a selected one of a plurality of physical environments, the computer-implemented method comprising:
generating a plurality of clusters, wherein a selected one of the plurality of clusters includes the selected one of the plurality of physical environments and at least one additional physical environment; and
implementing a regression model to generate an estimated engagement metric for each of the additional physical environments, wherein the regression model is generated by training data including one or more features of each of the plurality of physical environments, and wherein the regression model receives the engagement metric as an input.

15. The computer-implemented method of claim 10, wherein the engagement metric is one of an aggregated engagement score or a time series metric.

16. The computer-implemented method of claim 10, wherein the image processing model is configured to:
generate one or more bounding boxes corresponding to one or more persons within the image data;
determine a trajectory estimate for each of the one or more bounding boxes;
identify an entry event and an exit event for each of the one or more bounding boxes based on the trajectory estimate; and
output the processed image data based on the entry event and exit event for each of the one or more bounding boxes, wherein the person count is a count of entry events, and wherein the dwell time for each of the one or more bounding boxes is a time difference between the entry event and exit event for each of the one or more bounding boxes.

17. The computer-implemented method of claim 16, wherein the image processing model is configured to apply a region of interest process prior to generating the one or more bounding boxes.

18. The computer-implemented method of claim 10, wherein the image capture device is configured to generate the image data at a predetermined interval, and wherein the image data includes a predetermined length.

19. A computer-implemented method, comprising:
receiving a first training dataset including image data representative of an area of interest within a physical environment containing at least one engagement feature;
iteratively training a model framework to generate an intermediate model based on the first training dataset, wherein the model framework is configured to identify one or more bounding boxes representative of one or more individuals within the area of interest of the image data, wherein the model framework is configured to receive the image data as an input;
generating output image data including the image data and the one or more bounding boxes, wherein the output image data is generated by the intermediate model;
receiving a second training dataset, wherein the second training dataset includes modified output image data comprising the output image data with one or more bounding box corrections applied; and
iteratively training the intermediate model to generate a trained image processing model based on the second training dataset.

20. The computer-implemented method of claim 19, wherein the model framework comprises a deep learning model framework.
